(19) United States
(12) Patent Application Publication
(10) Pub. No.: US 2011/0090773 A1
(43) Pub. Date: Apr. 21, 2011

(54) APPARATUS FOR GENERATING VITERBI-PROCESSED DATA USING AN INPUT SIGNAL OBTAINED FROM READING AN OPTICAL DISC

(76) Inventors: Chih-Ching Yu, Hsinchu City (TW); Pi-Hai Liu, Hsinchu County (TW); Yu-Hsuan Lin, Taichung City (TW); Ying-Feng Huang, Chia-Yi Hsien (TW); Yuh Cheng, Hsinchu County (TW); Jin-Bin Yang, Hsinchu City (TW)

(21) Appl. No.: 12/854,145

(22) Filed: Aug. 10, 2010

Related U.S. Application Data
(63) Continuation-in-part of application No. 12/703,874, filed on Feb. 11, 2010.
(60) Provisional application No. 61/252,174, filed on Oct. 16, 2009.
(60) Provisional application No. 61/252,174, filed on Oct. 16, 2009.

(51) Int. Cl. G11B 20/10

(52) U.S. Cl. 369/47.15; G9B/20.009

(57) ABSTRACT

An apparatus for generating Viterbi-processed data using an input signal obtained from reading an optical disc includes a Viterbi decoding unit and a control circuit. The Viterbi decoding unit is arranged to process the input signal and generate the Viterbi-processed data. In addition, the control circuit is arranged to control at least one component of the apparatus based upon at least one signal within the apparatus. Additionally, the component includes a phase locked loop (PLL) processing unit, an equalizer, and/or the Viterbi decoding unit. An associated apparatus including an equalizer and a Viterbi module is further provided. An associated apparatus including a Viterbi decoding unit and a control circuit is also provided. An associated apparatus including an equalizer, at least one offset/gain controller, and a Viterbi module is further provided. An associated apparatus including an equalizer, a Viterbi module, and a peak/bottom/central (PK/BM/DC) detector is also provided.

### CROSS REFERENCE TO RELATED APPLICATIONS

This application claims the benefit of U.S. provisional application No. 61/252,174, which was filed on Oct. 16, 2009 and entitled “METHOD AND APPARATUS OF READING INFORMATION ON AN OPTICAL DISC” and is incorporated herein by reference. In addition, this application is a continuation-in-part application and further claims the benefit of U.S. non-provisional application Ser. No. 12/703,874, which was filed on Feb. 11, 2010 and entitled “APPARATUS FOR GENERATING VITERBI-PROCESSED DATA” and is incorporated herein by reference. Additionally, the aforementioned U.S. non-provisional application Ser. No. 12/703,874 also claims the benefit of U.S. provisional application No. 61/252,174.

### BACKGROUND

1. Field of the Invention

The invention relates generally to an apparatus for generating Viterbi-processed data, and more particularly, to an apparatus for generating Viterbi-processed data using an input signal obtained from reading an optical disc.

2. Description of the Related Art

As the development of computer accessory technology progresses, optical storage devices have become a mainstream for data storage. For example, the optical storage devices may comprise optical disc systems such as digital versatile disc (DVD) drives and Blu-ray disc (BD) drives. When an optical disc is retrieved, a radio-frequency (RF) signal is typically obtained. However, the RF signal reproduced from the optical disc may be corrupted due to a scratch on the optical disc or dust thereon. As a result, some problems may occur. For example, a Viterbi decoder may decode data (e.g. the data obtained from a derivative of the RF signal) by using erroneous target levels, leading to a poor decoding result with low data accuracy. Thus, a novel apparatus is required for preventing the Viterbi decoder from using erroneous target levels to decode the data.

### SUMMARY

It is therefore an objective of the claimed invention to provide apparatus for generating Viterbi-processed data using an input signal obtained from reading an optical disc, in order to solve the above-mentioned problems.

An exemplary embodiment of an apparatus for generating Viterbi-processed data using an input signal obtained from reading an optical disc comprises a Viterbi decoding unit and a control circuit. The Viterbi decoding unit is arranged to process the input signal and generate the Viterbi-processed data. In addition, the control circuit is arranged to control at least one component of the apparatus based upon at least one signal within the apparatus. Additionally, the component comprises a phase locked loop (PLL) processing unit, an equalizer, and/or the Viterbi decoding unit.

An exemplary embodiment of an apparatus for generating Viterbi-processed data using an input signal obtained from reading an optical disc comprises an equalizer and a Viterbi module. The equalizer is arranged to equalize a derivative of a radio frequency (RF) signal according to a reference signal to generate the input signal, wherein the RF signal is reproduced from the optical disc. In addition, the Viterbi module is arranged to process the input signal and generate the Viterbi-processed data according to the reference signal. Additionally, the apparatus processes at least one specific signal within the apparatus to generate the reference signal, and the at least one specific signal comprises the derivative of the RF signal and/or an output signal carrying the Viterbi-processed data. In particular, the specific signal can be a digital signal.

An exemplary embodiment of an apparatus for generating Viterbi-processed data using an input signal obtained from reading an optical disc comprises a Viterbi decoding unit and a control circuit. The Viterbi decoding unit is arranged to process the input signal and generate the Viterbi-processed data according to at least one target level of a plurality of target levels. In addition, the control circuit is arranged to control the Viterbi decoding unit based upon at least one signal within the apparatus, wherein the at least one signal within the apparatus is obtained from detecting at least one state corresponding to at least one portion of the target levels. Additionally, a number of the target levels is controlled by the control circuit.

An exemplary embodiment of an apparatus for generating Viterbi-processed data using an input signal obtained from reading an optical disc comprises an equalizer, at least one offset/gain controller, and a Viterbi module. The equalizer is arranged to equalize a derivative of an RF signal to generate the input signal, wherein the RF signal is reproduced from the optical disc. In addition, the at least one offset/gain controller is arranged to dynamically control an offset/gain of the input signal. Additionally, the Viterbi module is arranged to process the input signal and generate the Viterbi-processed data.

An exemplary embodiment of an apparatus for generating Viterbi-processed data using an input signal obtained from reading an optical disc comprises an equalizer, a Viterbi module, and a peak/bottom/central (PK/BM/DC) detector. The equalizer is arranged to equalize a derivative of an RF signal to generate the input signal, wherein the RF signal is reproduced from the optical disc. In addition, the Viterbi module is arranged to process the input signal and generate the Viterbi-processed data according to at least one target level. Additionally, the PK/BM/DC detector is arranged to obtain at least one PK/BM/DC value of the input signal. In particular, the Viterbi module dynamically adjusts the at least one target level according to the at least one PK/BM/DC value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for generating Viterbi-processed data using an input signal obtained from reading an optical disc according to a first embodiment of the present invention.

FIG. 2 is a diagram of an apparatus for generating Viterbi-processed data using an input signal obtained from reading an optical disc according to an embodiment of the present invention.

FIG. 3 is a diagram of an apparatus for generating Viterbi-processed data using an input signal obtained from reading an optical disc according to another embodiment of the present invention.

FIG. 4 is a diagram of an apparatus for generating Viterbi-processed data using an input signal obtained from reading an optical disc according to an embodiment of the present invention.

FIG. 5 is a diagram of an apparatus for generating Viterbi-processed data using an input signal obtained from reading an optical disc according to another embodiment of the present invention.

FIG. 6A illustrates target levels that can be utilized in the apparatus shown in FIG. 1 according to an embodiment of the present invention, where this embodiment is a variation of the first embodiment.

FIG. 6B illustrates an exemplary waveform and associated target levels according to the embodiment shown in FIG. 6A.

FIG. 7 is a diagram of an apparatus for generating Viterbi-processed data using an input signal obtained from reading an optical disc according to an embodiment of the present invention.

FIG. 8A is a diagram of an apparatus for generating Viterbi-processed data using an input signal obtained from reading an optical disc according to another embodiment of the present invention.

FIG. 8B illustrates exemplary level values of target levels adjusted in the apparatus shown in FIG. 8A according to an embodiment of the present invention.

FIG. 9 is a diagram of an apparatus for generating Viterbi-processed data using an input signal obtained from reading an optical disc according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

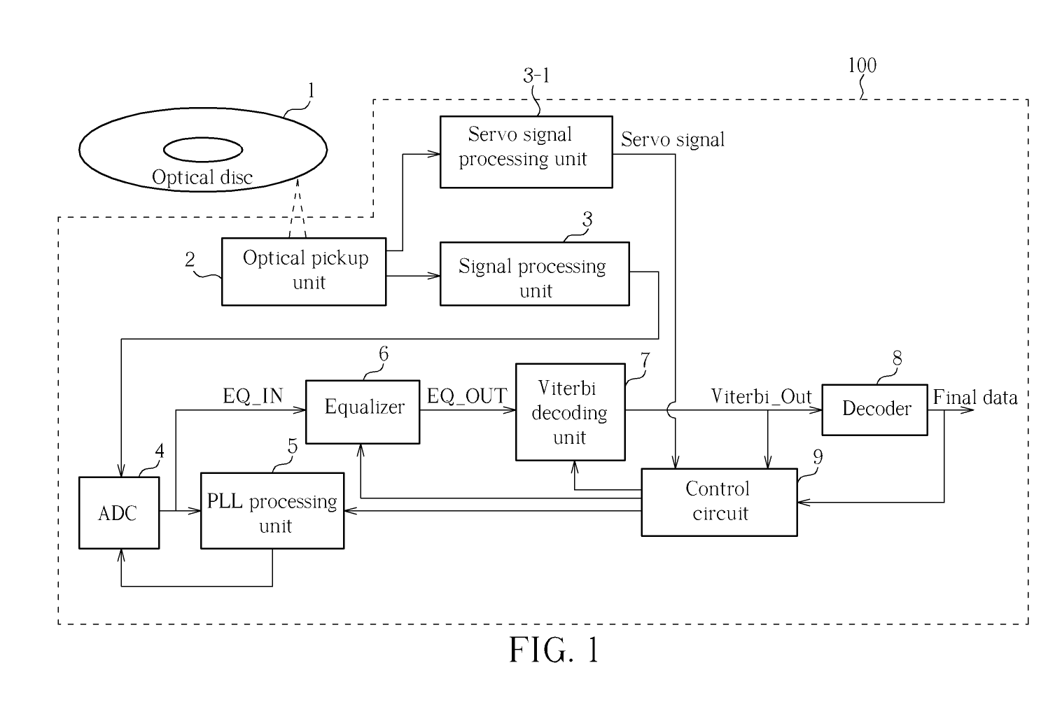

Please refer to FIG. 1, which illustrates a diagram of an apparatus 100 for generating Viterbi-processed data using an input signal obtained from reading an optical disc 1 according to a first embodiment of the present invention. In general, the apparatus 100 may comprise at least a portion of an optical disc system such as a digital versatile disc (DVD) drive or a Blu-ray disc (BD) drive. For example, the apparatus 100 may comprise a portion of the optical disc system mentioned above, such as at least a portion of a chipset or a combination of components/circuits/modules within the optical disc system. In another example, the apparatus 100 may comprise the whole of the optical disc system. As shown in FIG. 1, the apparatus 100 of this embodiment comprises an optical pickup unit 2, a signal processing unit 3, a servo signal processing unit 3-1, an analog-to-digital converting unit (ADC) 4, a phase locked loop (PLL) processing unit 5, an equalizer 6 such as a finite impulse response (FIR) equalizer, a Viterbi decoding unit 7, a decoder 8, and a control circuit 9.

In this embodiment, the optical pickup unit 2 retrieves information from the optical disc 1 and generates a radio frequency (RF) signal, where the RF signal reproduced from the optical disc 1 is sent to the signal processing unit 3 for further processing. The signal processing unit 3 is arranged to process the analog RF signal to generate a processed signal which has a higher signal quality, where the signal processing unit 3 may comprise a high pass filter for signal processing. The ADC 4 digitalizes the processed signal to generate a digital signal, where the ADC 4 may comprise a sampling circuit for analog-to-digital conversion. In particular, the digital signal is sent to the PLL processing unit 5 and the equalizer 6, where the PLL processing unit 5 is utilized for maintaining or creating a clock for the optical disc system.

In addition, the equalizer 6 performs an equalization operation on the digital signal generated from the ADC 4 to outputs an equalized signal to the Viterbi decoding unit 7 for data processing, where the digital signal can be regarded as an equalizer input signal EQ_IN, and the equalized signal can be regarded as an equalizer output signal EQ_OUT. The Viterbi decoding unit 7 is arranged to process the input signal thereof (more particularly, the equalizer output signal EQ_OUT), and generate the Viterbi-processed data mentioned above. For example, the Viterbi decoding unit 7 performs a partial response most likelihood (PRML) procedure on the input signal thereof and outputs the Viterbi-processed data accordingly, where an output signal of the Viterbi decoding unit 7, such as a Viterbi output signal Viterbi_Out, carries the Viterbi-processed data. In particular, the Viterbi-processed data can be regarded as Viterbi-decoded data. Additionally, the decoder 8 processes the Viterbi-processed data to generate final data, where the decoder 8 is arranged to decode the Viterbi-processed data to output the final data. Moreover, the decoder 8 demodulates the Viterbi-processed data in some other embodiments, such as some variations of this embodiment.

Please note that, based upon detection performed according to some detection signals from the optical pickup unit 2, the servo signal processing unit 3-1 generates at least one servo signal for access control regarding the optical disc 1. The control circuit 9 receives the servo signal from the servo signal processing unit 3-1, and further receives the Viterbi-processed data and the final data from the Viterbi decoding unit 7 and the decoder 8, respectively.

In addition, the control circuit 9 is arranged to control at least one component of the apparatus 100 based upon at least one signal within the apparatus 100. In general, according to this embodiment and some variations thereof, the aforementioned at least one component may comprise the PLL processing unit 5, the equalizer 6, and/or the Viterbi decoding unit 7. The control circuit 9 may control the component according to the Viterbi-processed data, the servo signal, and/or the final data. For example, the control circuit 9 may control the component according to at least two of the Viterbi-processed data, the servo signal, and the final data. More particularly, the control circuit 9 controls the component according to the Viterbi-processed data, the servo signal, and the final data. In another example, the component may comprise at least two of the PLL processing unit 5, the equalizer 6, and the Viterbi decoding unit 7. More particularly, the component comprises the PLL processing unit 5, the equalizer 6, and the Viterbi decoding unit 7.

According to some embodiments, in a situation where the control circuit 9 controls the component based upon the servo signal, the servo signal is arranged to notify the control circuit 9 of a defect, in order to perform defect pre-detection. As a result of the defect pre-detection, the apparatus 100 of these embodiments can operate properly by processing data in time and/or dynamically adjusting one or more signals in advance.

In general, according to the first embodiment and some variations thereof, the control circuit 9 can dynamically load at least one predetermined control parameter as at least one control parameter of the component according to at least one criterion. For example, the aforementioned at least one predetermined control parameter corresponds to optimized settings of the component. More particularly, the predetermined control parameter can be obtained in a situation where a bit error rate (BER) of the apparatus 100 reaches a minimum value thereof (e.g. a local minimum value or a global minimum value of the BER) or in a situation where the BER is less than a predetermined threshold. In another example, the aforementioned at least one predetermined control parameter comprises a first predetermined control parameter corresponding to a first bandwidth of the component, and further comprises a second predetermined control parameter corresponding to a second bandwidth of the component. In practice, the control circuit 9 can change one or more control parameters of a specific component (e.g. any of the aforementioned at least one component) when it is detected that there is a state transition of the specific component (e.g. the specific component enters a normal state or an abnormal state).

According to some variations of the first embodiment or a special case of the first embodiment, the control circuit 9 may control a level adjustor (not shown) within the Viterbi decoding unit 7 and determine whether to update the control parameters for the level adjustor. If it is determined not to update these control parameters, the control circuit 9 can set the level adjuster to hold the current value(s) of these control parameters or to load at least one predetermined value thereof (e.g. at least one predetermined control parameter for the level adjustor).

According to some variations of the first embodiment or a special case of the first embodiment, the control circuit 9 can also control the control parameters for the equalization of the equalizer 6, where these control parameters can be regarded as equalization parameters and/or equalizer parameters, and can be simply referred to as the EQ parameters. The control circuit 9 may determine whether to update the EQ parameters. If it is determined not to update the EQ parameters, the control circuit 9 can set the equalizer 6 to hold the current value(s) of these EQ parameters or to load at least one predetermined value thereof (e.g. at least one predetermined control parameter for the equalizer 6).

According to some variations of the first embodiment or a special case of the first embodiment, the control circuit 9 can also control the control parameters of the PLL processing unit 5 for the PLL control. For example, the control circuit 9 can determine whether to drive a frequency detector (not shown in FIG. 1) within the PLL processing unit 5 to perform frequency lock, where associated operations of the control circuit 9 may comprise: determining whether the location/position of the data sync is correct, i.e. determining whether the data frequency drifts; or determining whether the data can be decoded. Thus, the control circuit 9 can utilizes the results of these determining operations as flags to control the Viterbi decoding unit 7, the equalizer 6, and the PLL processing unit 5.

According to some variations of the first embodiment, the control circuit 9 can control the equalizer 6 and the Viterbi decoding unit 7 to load predetermined values as predetermined control parameters, respectively. Regarding the selection of the predetermined values, the control circuit 9 may utilize some control parameters corresponding to a situation where the error rate (e.g. the BER) is lower, or directly utilize a set of fixed values.

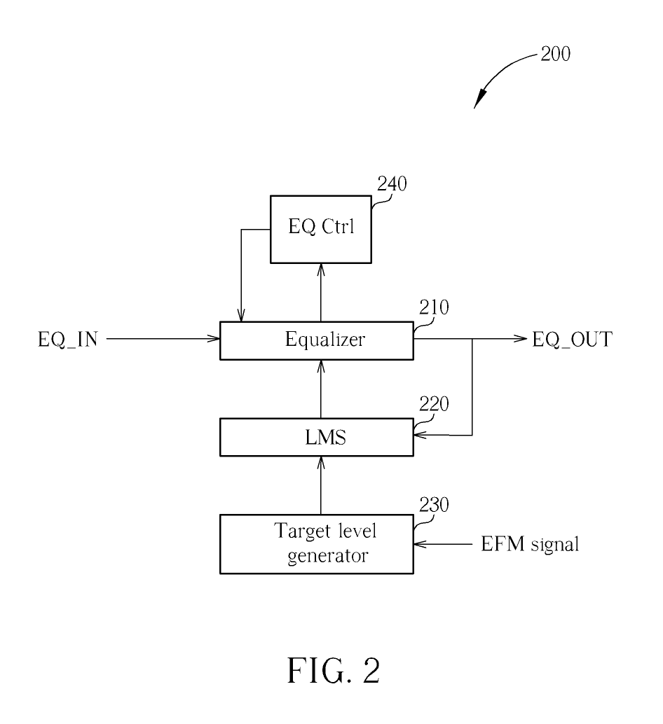

FIG. 2 is a diagram of an apparatus 200 for generating Viterbi-processed data using an input signal obtained from reading an optical disc according to an embodiment of the present invention. This embodiment can be regarded as a variation of the first embodiment, where the apparatus 200 may comprise at least a portion of the apparatus 100 of the first embodiment. For example, the equalizer 210 can be the equalizer 6 shown in FIG. 1, and the equalization control circuit 240 (labeled “EQ Ctrl” in FIG. 2) may represent at least a portion (e.g. a portion or all) of the control circuit 9 shown in FIG. 1.

According to this embodiment, the aforementioned at least one component comprises the equalizer 6, and the aforementioned at least one signal within the apparatus (which is regarded as the apparatus 200 in this embodiment) is obtained from detecting at least one state of the equalizer 6. As shown in FIG. 2, the apparatus 200 further comprises a least mean square (LMS) unit 220 (labeled “LMS” in FIG. 2) and a target level generator 230. The LMS unit 220 is arranged to adaptively adjust at least one control parameter of the equalizer 6 according to at least one target level and according to the equalizer output signal EQ_OUT output by the equalizer 6, where the equalizer output signal EQ_OUT is utilized as the input signal of the Viterbi decoding unit 7. In addition, the target level generator 230 is arranged to generate the aforementioned at least one target level according to an eight-to-fourteen modulation (EFM) signal within the apparatus 200. For example, the EFM signal can be the output signal of the Viterbi decoding unit 7, such as the Viterbi output signal Viterbi_Out mentioned above. In another example, the EFM signal can be a binary signal, where the apparatus 200 may comprise a binary signal enhancing module (not shown in FIG. 2) that is arranged to generate the binary signal according to the RF signal or according to a derivative of the RF signal.

Please note that, in the architecture shown in FIG. 2, the equalizer 210 outputs the control parameters converged between the equalizer 210 and the equalization control circuit 240, and the equalization control circuit 240 may check whether these control parameters are reasonable. For example, the equalization control circuit 240 may check whether any incorrect drift exists, or check whether any unreasonable gain boosting exists with respect to the frequency domain, in order to determine whether to load better predetermined control parameters for the equalization into the equalizer 210. Similar descriptions for this embodiment are not repeated in detail here.

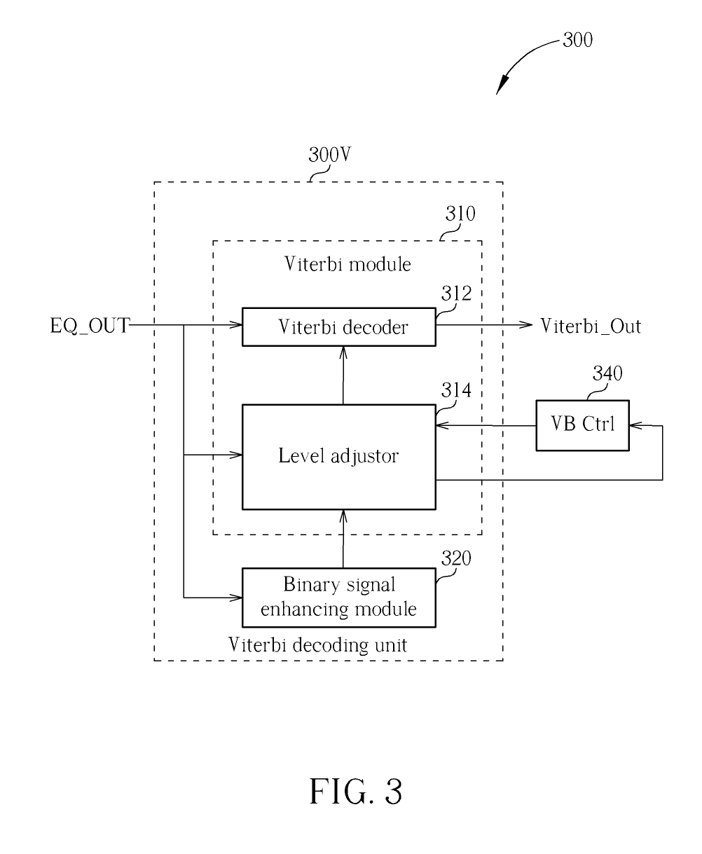

FIG. 3 is a diagram of an apparatus 300 for generating Viterbi-processed data using an input signal obtained from reading an optical disc according to another embodiment of the present invention. This embodiment can be regarded as a variation of the first embodiment, where the apparatus 300 may comprise at least a portion of the apparatus 100 of the first embodiment. For example, the Viterbi decoding unit 300V can be the Viterbi decoding unit 7 shown in FIG. 1, and the Viterbi control circuit 340 (labeled “VB Ctrl” in FIG. 3) may represent at least a portion (e.g. a portion or all) of the control circuit 9 shown in FIG. 1.

According to this embodiment, the component comprises the Viterbi decoding unit 7, and the signal within the apparatus (which is regarded as the apparatus 300 in this embodiment) is obtained from detecting at least one state of the Viterbi decoding unit 7. As shown in FIG. 3, the Viterbi decoding unit 300V comprises a Viterbi module 310 and a binary signal enhancing module 320, where the Viterbi module 310 comprises a Viterbi decoder 312 and a level adjustor 314. The Viterbi module 310 is arranged to process the input signal of the Viterbi decoding unit 300V, such as the equalizer output signal EQ_OUT, and generate the Viterbi-processed data according to a binary signal. In addition, the binary signal enhancing module 320 is arranged to generate the binary signal according to the input signal such as the equalizer output signal EQ_OUT. In particular, the Viterbi decoder 312 is arranged to process the input signal such as the equalizer output signal EQ_OUT according to at least one target level, where the aforementioned at least one state of the Viterbi decoding unit 7 (which can be the Viterbi decoding unit 300V in this embodiment) corresponds to the at least one target level, and the level adjustor 314 is arranged to dynamically adjust the aforementioned at least one target level according to the input signal (e.g. the equalizer output signal EQ_OUT) and the binary signal.

Please note that, in the architecture shown in FIG. 3, the level adjustor 314 outputs the control parameters converged in level adjustment operations of the level adjustor 314 to the Viterbi control circuit 340, and the Viterbi control circuit 340 may check whether these control parameters are reasonable. For example, the Viterbi control circuit 340 may check whether any incorrect drift exists to determine whether to load better predetermined control parameters for the level adjustment into the level adjustor 314. Similar descriptions for this embodiment are not repeated in detail here.

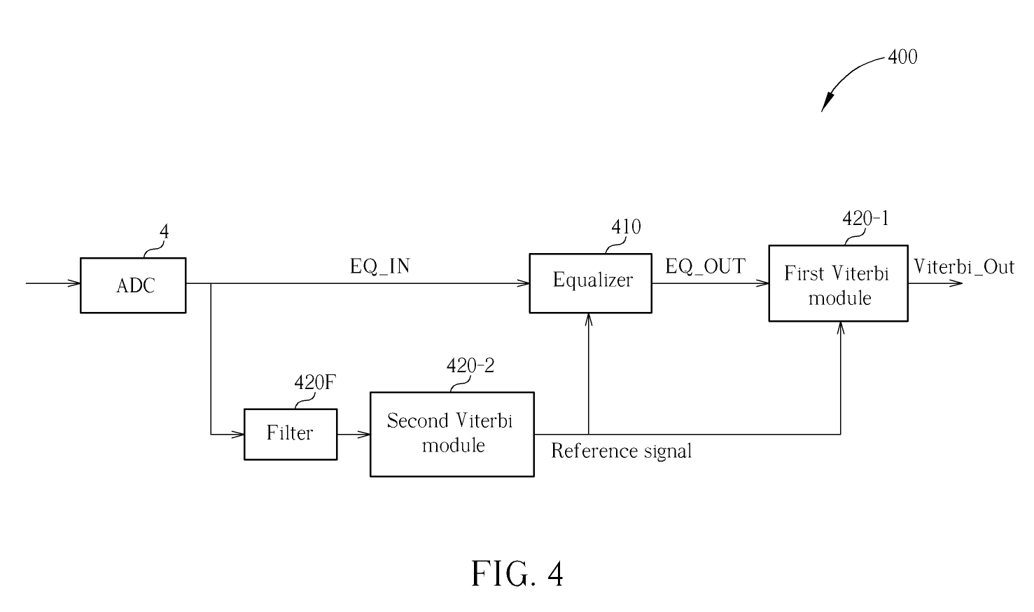

FIG. 4 is a diagram of an apparatus 400 for generating Viterbi-processed data using an input signal obtained from reading an optical disc according to an embodiment of the present invention. This embodiment can be regarded as a variation of the first embodiment, where the apparatus 400 may comprise at least a portion of the apparatus 100 of the first embodiment. For example, the equalizer 410 can be the equalizer 6 shown in FIG. 1, and the first Viterbi module 420-1 may represent at least a portion (e.g. a portion or all) of the Viterbi decoding unit 7 shown in FIG. 1.

In general, according to this embodiment or some variations of this embodiment, the equalizer 410 is arranged to equalize a derivative of the RF signal according to a reference signal, in order to generate the input signal of the first Viterbi module 420-1, such as the equalizer output signal EQ_OUT, where the derivative of the RF signal in this embodiment can be a digital signal output by the ADC 4, such as the equalizer input signal EQ_IN mentioned above. In addition, the first Viterbi module 420-1 is arranged to process the input signal such as the equalizer output signal EQ_OUT and generate the Viterbi-processed data (which is carried by the Viterbi output signal Viterbi_Out, for example) according to the same reference signal. Please note that the apparatus 400 of this embodiment or some variations of this embodiment processes at least one digital signal within the apparatus 400 to generate the reference signal, and the aforementioned digital signal comprises the derivative of the RF signal and/or an output signal carrying the Viterbi-processed data.

For example, in a situation where the digital signal comprises the derivative of the RF signal, the apparatus 400 further comprises a second Viterbi module 420-2 arranged to process the derivative of the RF signal or a filtered version of the derivative of the RF signal to generate the reference signal mentioned above. More particularly, in this embodiment, the apparatus 400 further comprises a filter 420F arranged to filter the RF signal to generate the filtered version of the derivative of the RF signal, where the second Viterbi module 420-2 is arranged to process the filtered version of the derivative of the RF signal to generate the reference signal. In another example, in a situation where the digital signal comprises the derivative of the RF signal, the second Viterbi module 420-2 is arranged to process the derivative of the RF signal to generate the reference signal, where the filter 420F can be omitted for simplicity. As a result of omitting the filter 420F, interdependency between the second Viterbi module 420-2 and the equalizer 410 may exist.

Please note that the architecture shown in FIG. 4 is utilized for preventing instability due to feedback. In addition, the reference signal is provided by the second Viterbi module 420-2, and the input signal of the second Viterbi module 420-2 is provided by an independent filter such as the filter 420F. By utilizing this independent filter, the interdependency between the second Viterbi module 420-2 and the equalizer 410 is reduced, and there is no feedback path in this embodiment. As a result, occurrence of the instability can be prevented.

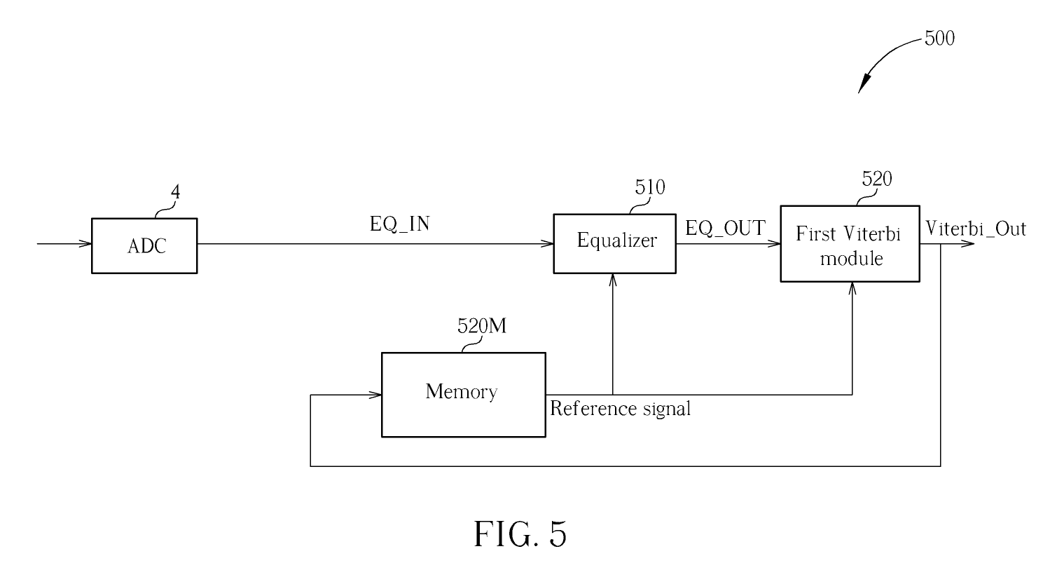

In order to further enhance the correctness of the equalizer output signal EQ_OUT output by the equalizer 410 shown in FIG. 4, it is also suggested in some variations of this embodiment to provide the equalizer 410 with the output of the first Viterbi module 420-1 (not shown), for being utilized in the equalizer 410 of these variations. In this manner, however, a feedback path is generated. Regarding this, the present invention further provides the architecture shown in FIG. 5, in order to relief this problem.

FIG. 5 is a diagram of an apparatus 500 for generating Viterbi-processed data using an input signal obtained from reading an optical disc according to another embodiment of the present invention. This embodiment can be regarded as a variation of the first embodiment, where the apparatus 500 may comprise at least a portion of the apparatus 100 of the first embodiment. For example, the equalizer 510 can be the equalizer 6 shown in FIG. 1, and the first Viterbi module 520 may represent at least a portion (e.g. a portion or all) of the Viterbi decoding unit 7 shown in FIG. 1. In addition, this embodiment can further be regarded as a variation of the embodiment shown in FIG. 4.

According to this embodiment, in a situation where the aforementioned at least one digital signal comprises the output signal carrying the Viterbi-processed data (which is carried by the Viterbi output signal Viterbi_Out, for example), the apparatus 500 further comprises a memory 520M. The memory 520M is arranged to temporarily store a previous version of the Viterbi-processed data, where the reference signal corresponds to the previous version of the Viterbi-processed data, and more particularly, carries the previous version of the Viterbi-processed data. For example, the previous version of the Viterbi-processed data is generated by reading the optical disc 1 at one time, and the Viterbi-processed data is generated by re-reading the optical disc 1 at another time.

More specifically, under control of the control circuit 9 in FIG. 1 of this embodiment, the architecture shown in FIG. 5 stores the digital output of the first Viterbi module 520 (e.g. the previous version of the Viterbi-processed data) into the memory 520M. Then, in a situation where the optical pickup unit 2 goes back to the original location/position corresponding to the same target address on the optical disc 1, re-reading the optical disc 1 can be performed. By utilizing the reference signal, the apparatus 500 (and more particularly, a memory interface circuit of the memory 520M) outputs the above-mentioned digital output that is originally stored in the memory 520M to the equalizer 510 and the first Viterbi module 520 for further use, where the reference signal carries the previous version of the Viterbi-processed data. As a result, the architecture shown in FIG. 5 not only can achieve the best quality of the digital output, but also can operate without being interfered by the instability problem due to feedback.

According to some variations of this embodiment, when needed, the re-reading operation can be repeated to obtain a later version of the Viterbi-processed data. Typically, the quality of the later version of the Viterbi-processed data is better than the previous version(s) of the Viterbi-processed data.

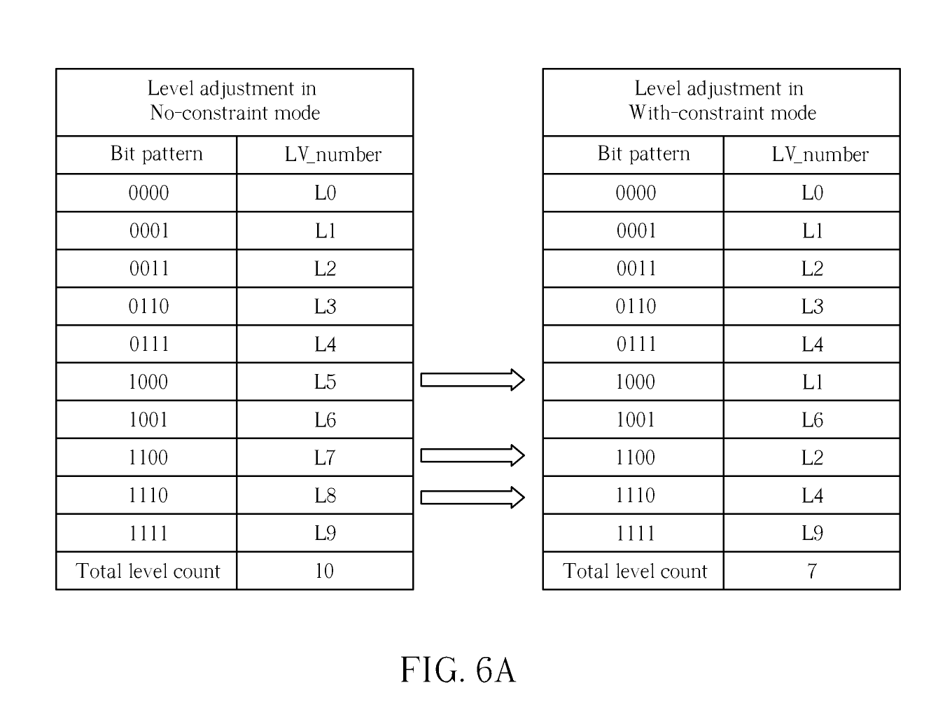

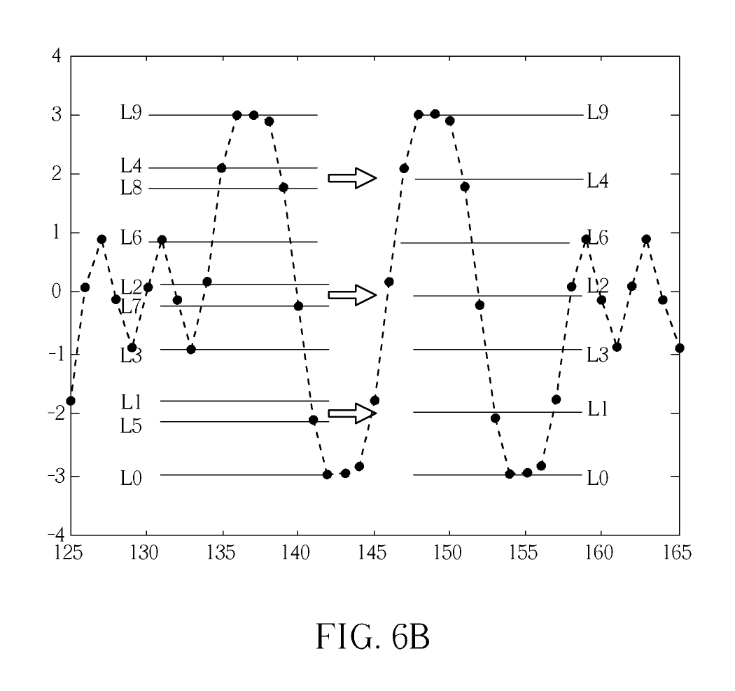

Please refer to FIGS. 6A-6B. FIG. 6A illustrates target levels (e.g. the target levels labeled with the level value (LV) number LV_number such as L0, L1, . . . , L9) that can be utilized in the apparatus 100 shown in FIG. 1 according to an embodiment of the present invention, and FIG. 6B illustrates an exemplary waveform and associated target levels according to the embodiment shown in FIG. 6A, where this embodiment is a variation of the first embodiment.

According to this embodiment, the Viterbi decoding unit 7 is arranged to process the input signal thereof and generate the Viterbi-processed data (which is carried by the Viterbi output signal Viterbi_Out, for example) according to at least one target level, and the control circuit 9 is arranged to control the Viterbi decoding unit 7 based upon at least one signal within the apparatus 100 of this embodiment, where the aforementioned at least one signal within the apparatus 100 is obtained from detecting at least one state corresponding to at least one portion of the target levels. In particular, the number of the target levels is controlled by the control circuit 9. For example, the target levels comprise a first target level corresponding to a rising edge, and further comprise a second target level corresponding to a falling edge, and the control circuit 9 controls the first target level and the second target level to merge into a merged target level. More specifically, in this embodiment, the first target level and the second target level are utilized in a no-constraint mode of the apparatus 100, and the merged target level is utilized in a with-constraint mode of the apparatus 100.

Referring to the left half side of each of FIGS. 6A-6B, during the level adjustment in the no-constraint mode, the target levels {L0, L1, L2, L3, L4, L5, L6, L7, L8, L9} are utilized in response to the bit patterns {0000, 0001, 0011, 0110, 0111, 1000, 1001, 1100, 1110, 1111} (e.g. the bit patterns of EFM data carried by the derivative of the RF signal), respectively. More specifically, in a set of partial digital waveforms that are symmetric in their bit patterns, the rising edge and the falling edge respectively has the reference levels thereof. That is, the rising edge has its own reference level and the falling edge has its own reference level. For example, the bit patterns 0011 and 1100 shown in the left half of FIG. 6A are respectively associated to the target level L2 and the target level L7. In another example, the bit patterns 0111 and 1110 shown in the left half of FIG. 6A are respectively associated to the target level L4 and the target level L8. Thus, the total level count of the no-constraint mode (i.e. the number of target levels utilized in the no-constraint mode) is equal to 10.

Referring to the right half side of each of FIGS. 6A-6B, during the level adjustment in the with-constraint mode, the target levels {L0, L1, L2, L3, L4, L1, L6, L2, L4, L9} are utilized in response to the bit patterns {0000, 0001, 0011, 0110, 0111, 1000, 1001, 1100, 1110, 1111}, respectively. More specifically, in a set of partial digital waveforms that are symmetric in their bit patterns, the rising edge and the falling edge have a common reference level such as the merged target level mentioned above. For example, the bit patterns 0011 and 1100 shown in the right half side of FIG. 6A share the same target level L2. In another example, the bit patterns 0111 and 1110 shown in the right half side of FIG. 6A share the same target level L4. Thus, the total level count of the with-constraint mode (i.e. the number of target levels utilized in the with-constraint mode) is equal to 7 since three set of the target levels (L1, L5), (L2, L7), and (L4, L8) illustrated in the left half side of FIG. 6B are merge into associated merged target levels illustrated in the right half side of FIG. 6B, respectively. In practice, the implementation details disclosed in this embodiment can be applied to various kinds of maximum likelihood (ML) systems. Similar descriptions for this embodiment are not repeated in detail here.

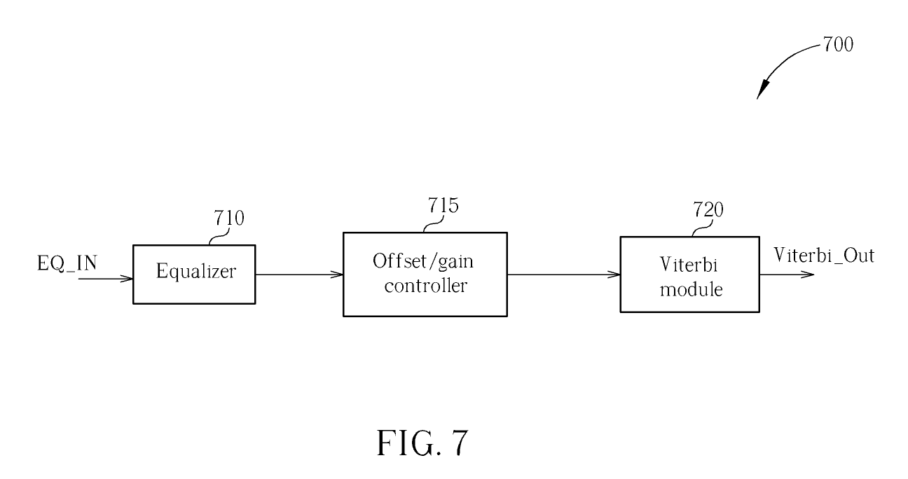

FIG. 7 is a diagram of an apparatus 700 for generating Viterbi-processed data using an input signal obtained from reading an optical disc according to an embodiment of the present invention. This embodiment can be regarded as a variation of the first embodiment, where the apparatus 700 may comprise at least a portion of the apparatus 100 of the first embodiment. For example, the equalizer 710 can be the equalizer 6 shown in FIG. 1, and the Viterbi module 720 may represent at least a portion (e.g. a portion or all) of the Viterbi decoding unit 7 shown in FIG. 1.

According to this embodiment, the apparatus 700 further comprises at least one offset/gain controller 715. The equalizer 710 is arranged to equalize the derivative of the RF signal (e.g. the equalizer input signal EQ_IN) to generate the input signal of the Viterbi module 720, and the offset/gain controller 715 is arranged to dynamically control an offset/gain of the input signal of the Viterbi module 720, where the Viterbi module 720 is arranged to process the input signal of the Viterbi module 720 and generate the Viterbi-processed data (which is carried by the Viterbi output signal Viterbi_Out, for example).

In general, the offset/gain controller 715 may comprise an offset controller arranged to eliminate the offset, and/or comprise a gain controller arranged to perform gain adjustment. For example, the offset/gain controller 715 may comprise merely the offset controller arranged to eliminate the offset, or may comprise merely the gain controller arranged to perform gain adjustment. In another example, the offset/gain controller 715 may comprise both the offset controller and the gain controller mentioned above. This is for illustrative purposes only, and is not meant to be a limitation of the present invention. According to a variation of this embodiment, the offset/gain controller 715 may comprise an offset and gain controller arranged to eliminate the offset and perform gain adjustment.

As shown in FIG. 7, the architecture of this embodiment does not dynamically adjust the level adjustor of the Viterbi module 720, where offset drifts of signals and variations of signal magnitudes can be adjusted by the offset/gain controller 715. For example, in a situation where the offset/gain controller 715 comprises both the offset controller and the gain controller mentioned above, it is suggested to first utilize the offset controller to eliminate the offset of the output of the equalizer 710, and further utilize the gain controller to perform gain adjustment, and then utilize the Viterbi module 720 to decode data, where the level adjustor of the Viterbi module 720 may be not dynamically adjusted. Similar descriptions for this embodiment are not repeated in detail here.

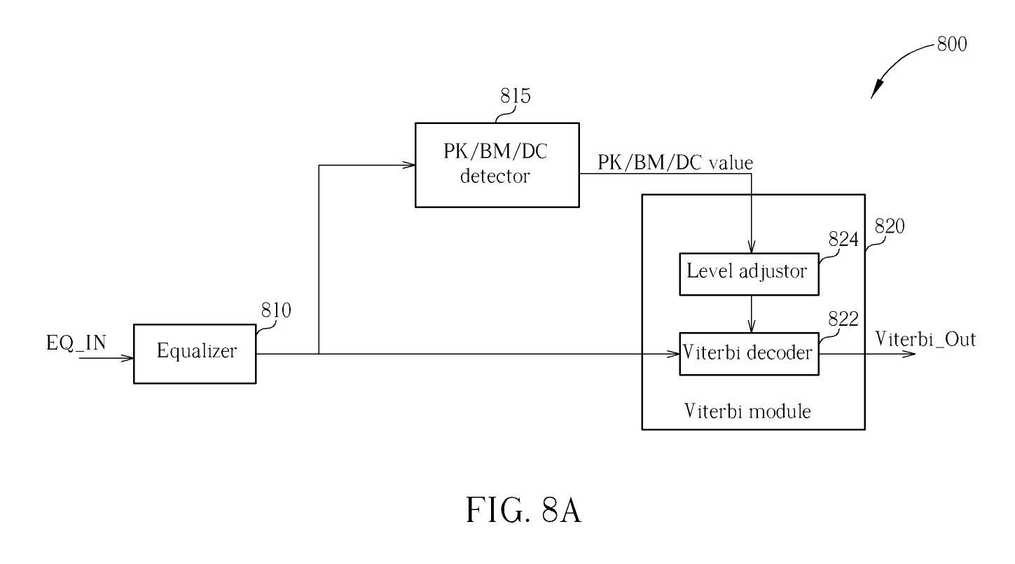

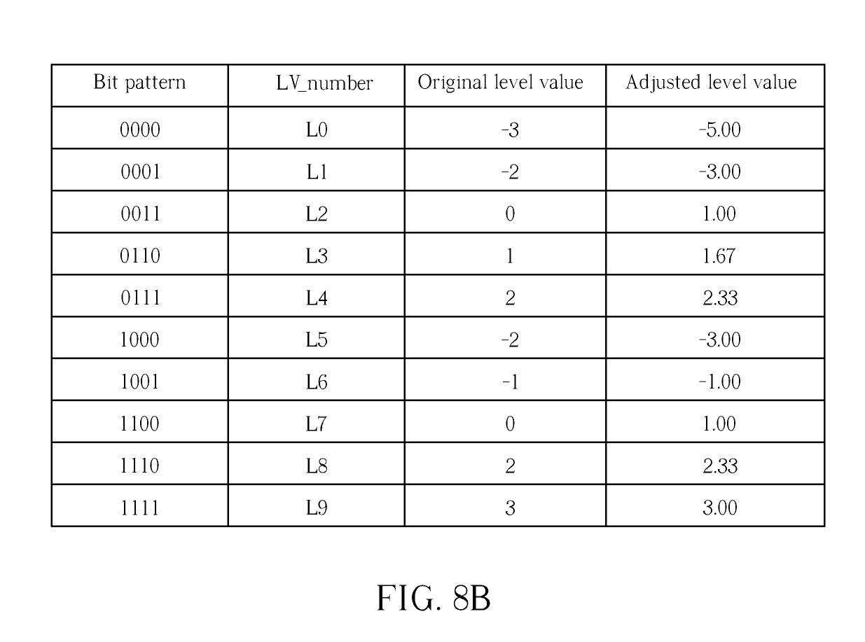

FIG. 8A is a diagram of an apparatus 800 for generating Viterbi-processed data using an input signal obtained from reading an optical disc according to another embodiment of the present invention. This embodiment can be regarded as a variation of the first embodiment, where the apparatus 800 may comprise at least a portion of the apparatus 100 of the first embodiment. For example, the equalizer 810 can be the equalizer 6 shown in FIG. 1, and the Viterbi module 820 may represent at least a portion (e.g. a portion or all) of the Viterbi decoding unit 7 shown in FIG. 1. In addition, the Viterbi module 820 comprises a Viterbi decoder 822 and a level adjustor 824, such as those mentioned in some embodiment/variations disclosed above.

According to this embodiment, the apparatus 800 further comprises a peak/bottom/central (PK/BM/DC) detector 815. The equalizer 810 is arranged to equalize the derivative of the RF signal (e.g. the equalizer input signal EQ_IN) to generate the input signal of the Viterbi module 820, the Viterbi module 820 is arranged to process the input signal of the Viterbi module 820 and generate the Viterbi-processed data (which is carried by the Viterbi output signal Viterbi_Out, for example) according to at least one target level, where the PK/BM/DC detector 815 may be arranged to obtain at least one of a PK value (peak value, i.e. largest value), a BM value (bottom value, i.e. smallest value), and a DC value (direct current value, i.e. central value) of the input signal of the Viterbi module 820, and the Viterbi module 820 dynamically adjusts the target level according to the PK/BM/DC value. More specifically, the Viterbi decoder 822 is arranged to process the input signal of the Viterbi module 820 according to the target level, and the level adjustor 824 is arranged to dynamically adjust the target level according to the PK/BM/DC value.

For example, the PK/BM/DC detector 815 may obtain a peak value V_{PK}, a bottom value V_{BM}, and a central value V_{DC} of the input signal of the Viterbi module 820. That is, the PK/BM/DC value comprises the peak value V_{PK}, the bottom value V_{BM}, and the central value V_{DC}. In addition, the target levels controlled by the level adjustor 824 of the Viterbi module 820 are adjusted and generated according to the peak value V_{PK}, the bottom value V_{BM}, and the central value V_{DC}. Taking the target levels {L0, L1, L2, L3, L4, L5, L6, L7, L8, L9} shown in the left half side of each of FIGS. 6A-6B as examples of the target levels before adjustment, the new target levels that are adjusted and generated according to the peak value V_{PK}, the bottom value V_{BM}, and the central value V_{DC} can be referred to as the target levels {L0′, L1′, L2′, L3′, L4′, L5′, L6′, L7′, L8′, L9′}. Thus, the target levels {L0′, L1′, L2′, L3′, L4′, L5′, L6′, L7′, L8′, L9′} can be utilized by the Viterbi module 820. Suppose that the notations Li and Li′ are respectively utilized for representing the target levels {L0, L1, L2, L3, L4, L5, L6, L7, L8, L9} and {L0′, L1′, L2′, L3′, L4′, L5′, L6′, L7′, L8′, L9′} with i being the associated index {0, 1, 2, 3, 4, 5, 6, 7, 8, 9} of the target levels {L0, L1, L2, L3, L4, L5, L6, L7, L8, L9} or {L0′, L1′, L2′, L3′, L4′, L5′, L6′, L7′, L8′, L9′}. In this embodiment, the relationships between the target levels Li′ and Li can be expressed as follows:

Li′=Li*((V_{PK}−V_{DC})/(L9−L0))*2+V_{DC}, in a situation where Li>0; and

Li′=Li*((V_{DC}−V_{BM})/(L9−L0))*2+V_{DC}, in a situation where Li≦0.

FIG. 8B illustrates exemplary level values of the target levels adjusted in the apparatus 800 shown in FIG. 8A according to an embodiment of the present invention, where the third column of the table shown in FIG. 8B represents the original level values of the target levels (i.e. the level values of the target levels {L0, L1, L2, L3, L4, L5, L6, L7, L8, L9} mentioned above), and the fourth column of the table shown in FIG. 8B represents the adjusted level values of the target levels (i.e. the level values of the target levels {L0′, L1′, L2′, L3′, L4′, L5′, L6′, L7′, L8′, L9′} mentioned above). For example, given that the target levels {L0, L1, L2, L3, L4, L5, L6, L7, L8, L9} are respectively equal to {−3, −2, 0, 1, 2, −2, −1, 0, 2, 3}, when V_{PK}=3, V_{BM}=−5, and V_{DC}=1, the target levels {L0′, L1′, L2′, L3′, L4′, L5′, L6′, L7′, L8′, L9′} are equal to {−5.00, −3.00, 1.00, 1.67, 2.33, −3.00, −1.00, 1.00, 2.33, 3.00}, respectively. In practice, the implementation details disclosed in this embodiment can be applied to various kinds of maximum likelihood (ML) systems. Similar descriptions for this embodiment are not repeated in detail here.

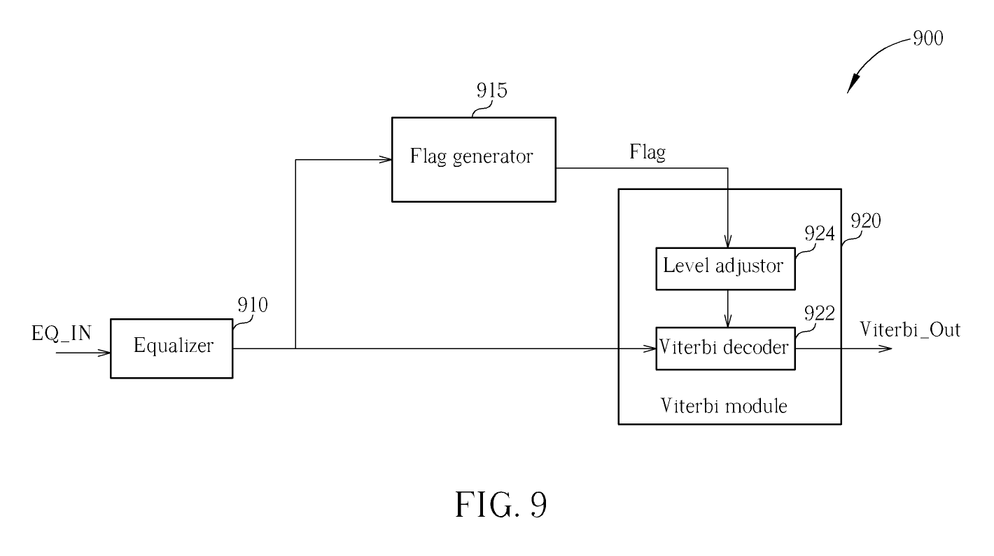

FIG. 9 is a diagram of an apparatus 900 for generating Viterbi-processed data using an input signal obtained from reading an optical disc according to an embodiment of the present invention. This embodiment can be regarded as a variation of the first embodiment, where the apparatus 900 may comprise at least a portion of the apparatus 100 of the first embodiment. For example, the equalizer 910 can be the equalizer 6 shown in FIG. 1, and the Viterbi module 920 may represent at least a portion (e.g. a portion or all) of the Viterbi decoding unit 7 shown in FIG. 1.

According to this embodiment, the apparatus 900 further comprises at least one flag generator 915. The equalizer 910 is arranged to equalize the derivative of the RF signal (e.g. the equalizer input signal EQ_IN) to generate the input signal of the Viterbi module 920, the Viterbi module 920 is arranged to process the input signal of the Viterbi module 920 and generate the Viterbi-processed data (which is carried by the Viterbi output signal Viterbi_Out, for example) according to at least one target level, where the flag generator 915 is arranged to generate at least one flag, and the Viterbi module 920 dynamically adjusts the target level according to the flag. More specifically, the Viterbi decoder 922 is arranged to process the input signal of the Viterbi module 920 according to the target level, and the level adjustor 924 is arranged to dynamically adjust the target level according to the flag.

In this embodiment, the flag may trigger the level adjustor 924 to load one or more predetermined control parameters. For example, in a situation where the aforementioned at least one component comprises the Viterbi module 920, the flag can be set as a first predetermined flag value for triggering the level adjustor 924 to load the first predetermined control parameter corresponding to the first bandwidth, or can be set as a second predetermined flag value for triggering the level adjustor 924 to load the second predetermined control parameter corresponding to the second bandwidth. More particularly, the flag generator 915 generates the flag according to situations of the signals (e.g. the derivative of the RF signal and/or the equalizer input signal EQ_IN), and the Viterbi module 920 then adjusts the speed (or bandwidth) of the level adjustor 924 according to this flag. For example, this flag can be a Defect flag, and the apparatus 900 switches the speed (or bandwidth) of the level adjustor 924 according to this Defect Flag. In practice, when the Defect Flag indicates that one or more defects exist, the apparatus 900 can dynamically decrease the speed (or bandwidth) of the level adjustor 924, in order to prevent the level adjustor 924 from rapidly adjusting the target levels erroneously. On the contrary, when the Defect Flag indicates that no defect exists, the apparatus 900 can dynamically increase the speed (or bandwidth) of the level adjustor 924, in order to make the level adjustor 924 to work hard in its optimized configuration. Similar descriptions for this embodiment are not repeated in detail here.

It is an advantage of the present invention that the present invention apparatus can generate the Viterbi-processed data correctly. More particularly, the apparatus can generate the Viterbi-processed data without using erroneous target levels. In addition, the related art problem due to a scratch on the optical disc or dust thereon is no longer an issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for generating Viterbi-processed data using an input signal obtained from reading an optical disc, comprising:
a Viterbi decoding unit arranged to process the input signal and generate the Viterbi-processed data; and
a control circuit arranged to control at least one component of the apparatus based upon at least one signal within the apparatus, wherein the component comprises a phase locked loop (PLL) processing unit, an equalizer, and/or the Viterbi decoding unit.

2. The apparatus of claim 1, wherein the apparatus comprises a decoder arranged to demodulate the Viterbi-processed data to output final data, and further comprises a servo signal processing unit arranged to generate at least one servo signal for access control regarding the optical disc; and the control circuit controls the component according to the Viterbi-processed data, the servo signal, and/or the final data.

3. The apparatus of claim 2, wherein when the control circuit controls the component based upon the servo signal, the servo signal is arranged to notify the control circuit of a defect, in order to perform defect pre-detection.

4. The apparatus of claim 1, wherein the control circuit dynamically loads at least one predetermined control parameter as a control parameter of the component according to a criterion.

5. The apparatus of claim 4, wherein the predetermined control parameter corresponds to optimized settings of the component.

6. The apparatus of claim 5, wherein the predetermined control parameter is obtained in a situation where a bit error rate (BER) of the apparatus reaches a minimum value thereof or in a situation where the BER is less than a predetermined threshold.

7. The apparatus of claim 4, wherein the at least one predetermined control parameter comprises a first predetermined control parameter corresponding to a first bandwidth of the component, and further comprises a second predetermined control parameter corresponding to a second bandwidth of the component.

8. The apparatus of claim 1, wherein the at least one component comprises the equalizer, and the at least one signal within the apparatus is obtained from detecting at least one state of the equalizer; and the apparatus further comprises:
a least mean square (LMS) unit arranged to adaptively adjust at least one control parameter of the equalizer according to at least one target level and an equalized signal output by the equalizer, wherein the equalized signal is utilized as the input signal of the Viterbi decoding unit.

9. The apparatus of claim 8, wherein the apparatus further comprises:
a target level generator arranged to generate the target level according to an eight-to-fourteen modulation (EFM) signal within the apparatus.

10. The apparatus of claim 1, wherein the at least one component comprises the Viterbi decoding unit, and the at least one signal within the apparatus is obtained from detecting at least one state of the Viterbi decoding unit; and the Viterbi decoding unit comprises:
a Viterbi module arranged to process the input signal and generate the Viterbi-processed data according to a binary signal; and
a binary signal enhancing module arranged to generate the binary signal according to the input signal.

11. The apparatus of claim 10, wherein the Viterbi module comprises:
a Viterbi decoder arranged to process the input signal according to at least one target level, wherein the at least one state of the Viterbi decoding unit corresponds to the at least one target level; and
a level adjustor arranged to dynamically adjust the at least one target level according to the input signal and the binary signal.

12. An apparatus for generating Viterbi-processed data using an input signal obtained from reading an optical disc, comprising:
an equalizer arranged to equalize a derivative of a radio frequency (RF) signal according to a reference signal to generate the input signal, wherein the RF signal is reproduced from the optical disc; and
a Viterbi module arranged to process the input signal and generate the Viterbi-processed data according to the reference signal;
wherein the apparatus processes at least one specific signal within the apparatus to generate the reference signal, and the at least one specific signal comprises the derivative of the RF signal and/or an output signal carrying the Viterbi-processed data.

13. The apparatus of claim 12, wherein in a situation where the specific signal comprises the derivative of the RF signal, the apparatus further comprises:
another Viterbi module arranged to process the derivative of the RF signal or a filtered version of the derivative of the RF signal to generate the reference signal.

14. The apparatus of claim 13, further comprising:
a filter arranged to filter the RF signal to generate the filtered version of the derivative of the RF signal;
wherein the other Viterbi module is arranged to process the filtered version of the derivative of the RF signal to generate the reference signal.

15. The apparatus of claim 12, wherein in a situation where the specific signal comprises the output signal carrying the Viterbi-processed data, the apparatus further comprises:
a memory arranged to temporarily store a previous version of the Viterbi-processed data, wherein the reference signal corresponds to the previous version of the Viterbi-processed data.

16. The apparatus of claim 15, wherein the previous version of the Viterbi-processed data is generated by reading the optical disc at one time, and the Viterbi-processed data is generated by re-reading the optical disc at another time.

17. An apparatus for generating Viterbi-processed data using an input signal obtained from reading an optical disc, comprising:
a Viterbi decoding unit arranged to process the input signal and generate the Viterbi-processed data according to at least one target level of a plurality of target levels; and
a control circuit arranged to control the Viterbi decoding unit based upon at least one signal within the apparatus, wherein the at least one signal within the apparatus is obtained from detecting at least one state corresponding to at least one portion of the target levels;
wherein a number of the target levels is controlled by the control circuit.

18. The apparatus of claim 17, wherein the target levels comprise a first target level corresponding to a rising edge, and further comprise a second target level corresponding to a falling edge; and the control circuit controls the first target level and the second target level to merge into a merged target level.

19. The apparatus of claim 18, wherein the first target level and the second target level are utilized in a no-constraint mode of the apparatus, and the merged target level is utilized in a with-constraint mode of the apparatus.

20. An apparatus for generating Viterbi-processed data using an input signal obtained from reading an optical disc, comprising:
an equalizer arranged to equalize a derivative of a radio frequency (RF) signal to generate the input signal, wherein the RF signal is reproduced from the optical disc;
at least one offset/gain controller arranged to dynamically control an offset/gain of the input signal; and
a Viterbi module arranged to process the input signal and generate the Viterbi-processed data.

21. The apparatus of claim 20, wherein the at least one offset/gain controller comprises:
an offset controller arranged to eliminate the offset; or
a gain controller arranged to perform gain adjustment.

22. The apparatus of claim 20, wherein the at least one offset/gain controller comprises:
an offset and gain controller arranged to eliminate the offset and perform gain adjustment.

23. An apparatus for generating Viterbi-processed data using an input signal obtained from reading an optical disc, comprising:
an equalizer arranged to equalize a derivative of a radio frequency (RF) signal to generate the input signal, wherein the RF signal is reproduced from the optical disc;
a Viterbi module arranged to process the input signal and generate the Viterbi-processed data according to at least one target level; and
a peak/bottom/central (PK/BM/DC) detector arranged to obtain at least one PK/BM/DC value of the input signal;
wherein the Viterbi module dynamically adjusts the at least one target level according to the at least one PK/BM/DC value.

24. The apparatus of claim 23, wherein the Viterbi module comprises:
a Viterbi decoder arranged to process the input signal according to the at least one target level; and
a level adjustor arranged to dynamically adjust the at least one target level according to the at least one PK/BM/DC value.
